(19) United States
(12) Patent Application Publication
(10) Pub. No.: US 2026/0296079 A1
(43) Pub. Date: Oct. 1, 2026

(54) PRINTING METHOD AND LIQUID DISCHARGE DEVICE

(71) Applicant: SEIKO EPSON CORPORATION, Tokyo (JP)

(72) Inventors: Takumi JOKO, SHIOJIRI-SHI (JP); Yuya NAKAMURA, SHIOJIRI-SHI (JP); Takayoshi KAGATA, SHIOJIRI-SHI (JP); Seiichi MATSUSHIMA, MATSUMOTO-SHI (JP); Kunihiro FUJITA, SHIOJIRI-SHI (JP)

(21) Appl. No.: 19/629,159

(22) Filed: Mar. 26, 2026

(30) Foreign Application Priority Data
Mar. 27, 2025 (JP) 2025-053156

(51) Int. Cl. B41M 3/12; B41J 2/005; B41J 2/21; B41M 3/00; B41J 2/01

(52) U.S. Cl. CPC B41M 3/12; B41J 2/0057; B41J 2/2114; B41M 3/006; B41M 3/008; B41J 2002/012

(57) ABSTRACT

A printing method for performing printing on a transfer medium using a liquid discharge device including a nozzle configured to discharge a color ink and a nozzle configured to discharge an adhesive liquid includes discharging a first amount of the adhesive liquid per unit area to an overlapping region in which an adhesion image formed by an adhesive dot formed of the adhesive liquid is superimposed on a color image formed by a color dot formed of the color ink, and discharging a second amount of the adhesive liquid per unit area to an adjacent region that is a region to which the color ink is not discharged and that is adjacent to the color image, the second amount being larger than the first amount.

The present application is based on, and claims priority from JP Application Serial Number 2025-053156, filed Mar. 27, 2025, the disclosure of which is hereby incorporated by reference herein in its entirety.

### BACKGROUND

### 1. Technical Field

The present disclosure relates to a printing method and a liquid discharge device.

### 2. Related Art

JP-A-2012-245660 discloses a recording device that records a color image formed with a color ink and an adhesion image formed with an adhesive liquid on a transfer medium. To improve transferability of the color image to be transferred to a transfer target medium, the recording device performs expansion processing of making a region of the adhesion image larger than a region of the color image by a predetermined number of pixels.

JP-A-2012-245660 is an example of the related art.

However, in the recording device disclosed in JP-A-2012-245660, even when the expansion processing is performed, when an amount of the color ink discharged to the transfer medium increases, the color ink may naturally spread on a surface of the transfer medium, and accordingly, a contour of the color image may be disturbed.

### SUMMARY

A printing method for performing printing on a transfer medium using a liquid discharge device including a nozzle configured to discharge a color ink and a nozzle configured to discharge an adhesive liquid, the printing method including: discharging a first amount of the adhesive liquid per unit area to an overlapping region in which an adhesion image formed by an adhesive dot formed of the adhesive liquid is superimposed on a color image formed by a color dot formed of the color ink; and discharging a second amount of the adhesive liquid per unit area to an adjacent region that is a region to which the color ink is not discharged and that is adjacent to the color image, the second amount being larger than the first amount.

A liquid discharge device is a liquid discharge device including: a nozzle configured to discharge a color ink; and a nozzle configured to discharge an adhesive liquid, in which a first amount of the adhesive liquid per unit area is discharged to an overlapping region in which an adhesion image formed by an adhesive dot formed of the adhesive liquid is superimposed on a color image formed by a color dot formed of the color ink, and a second amount of the adhesive liquid per unit area is discharged to an adjacent region that is a region to which the color ink is not discharged and that is adjacent to the color image, the second amount being larger than the first amount.

### BRIEF DESCRIPTION OF THE DRAWINGS

FIG. 1 is a block diagram illustrating a configuration of a liquid discharge device.

FIG. 2 is a schematic view illustrating a schematic configuration of the liquid discharge device.

FIG. 3 is a flowchart of transfer image control.

FIG. 4 is a view illustrating formation of a color image layer.

FIG. 5 is a view illustrating formation of an adhesion image layer.

FIG. 6 is a view illustrating how a transfer image is transferred.

FIG. 7 is a plan view illustrating dots formed on a transfer medium.

FIG. 8 is a cross-sectional view taken along a line A-A in FIG. 7.

FIG. 9 is a cross-sectional view taken along the line A-A in FIG. 7 when a white dot is discharged in an overlapping manner.

FIG. 10 is a plan view illustrating dots formed on a transfer medium according to a second embodiment.

FIG. 11 is a cross-sectional view taken along the line A-A in FIG. 7 in a third embodiment.

FIG. 12 is a plan view illustrating dots formed on a transfer medium in a fourth embodiment.

### DESCRIPTION OF EMBODIMENTS

### 1. First Embodiment

Hereinafter, a liquid discharge device and a printing method for performing printing on a transfer medium using the liquid discharge device according to the embodiment will be described with reference to the drawings. The liquid discharge device according to the embodiment is an inkjet printer that prints an image, such as a character or a photograph to be transferred to a transfer target medium, such as a T-shirt, on a transfer medium. When the image is printed on the transfer medium, the liquid discharge device discharges a color ink for forming a color image. The liquid discharge device can also discharge an adhesive liquid for transferring the color image to the transfer target medium onto the color image. As the transfer medium, a transfer film or the like capable of transferring an image by a direct to film (DTF) method can be used.

In the drawings below, the scale of each member is different from the actual scale to make each member large enough to be recognizable. In the drawings, the same configurations are denoted by the same reference numerals, and a repeated description thereof will be omitted. In the drawings, an X axis, a Y axis, and a Z axis are illustrated as necessary, as coordinate axes orthogonal to each other. Arrows are attached to the X axis, the Y axis, and the Z axis, respectively. In each of the X axis, the Y axis, and the Z axis, a direction of the arrow is a positive direction, and a direction opposite to the direction of the arrow is a negative direction.

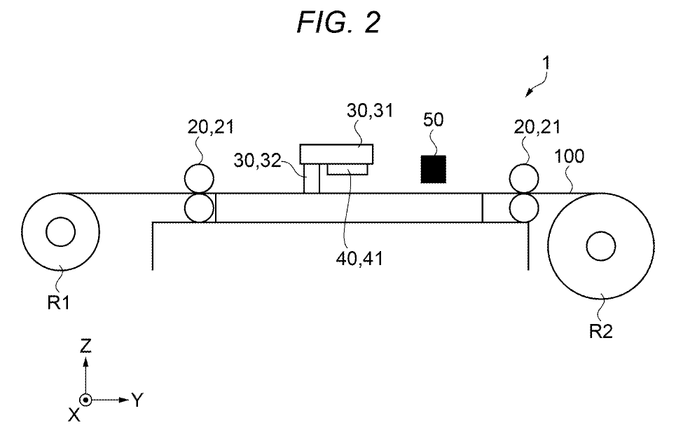

In FIG. 2, a direction along the X axis corresponds to a main scanning direction, and a direction along the Y axis corresponds to a sub scanning direction. A transport direction in which a transfer medium 100 is transported is also referred to as downstream, and a direction opposite to the downstream direction is also referred to as upstream.

### 1-1. Configuration of Liquid Discharge Device

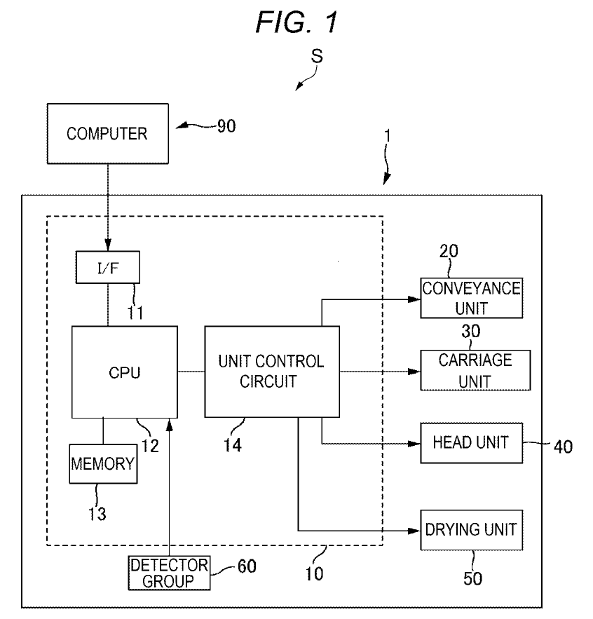

A configuration of a liquid discharge device 1 will be described with reference to FIGS. 1 and 2. Hereinafter, a print system S in which the liquid discharge device 1 and a computer 90 are connected will be described as an example.

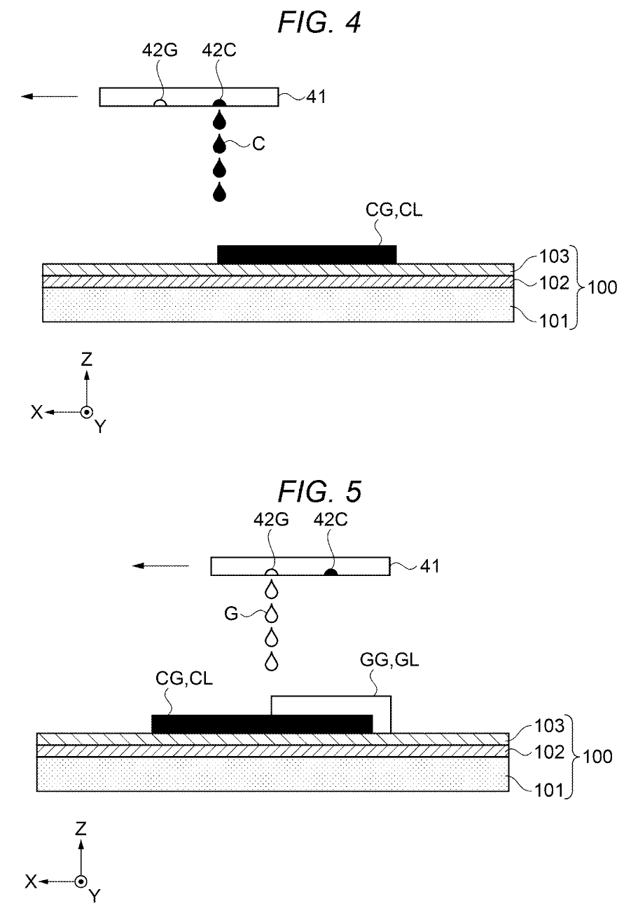

As illustrated in FIG. 1, the print system S includes the liquid discharge device 1 and the computer 90. The liquid discharge device 1 and the computer 90 are communicably connected to each other. The liquid discharge device 1 performs printing by discharging a color ink C (see FIG. 4) and an adhesive liquid G (see FIG. 5) onto the transfer medium 100 (see FIG. 2). In the following description, when the color ink C and the adhesive liquid G are not distinguished from each other, they are also simply referred to as a liquid. The computer 90 may be a tablet, a smartphone, or the like.

The computer 90 includes a driver that controls the liquid discharge device 1. The driver is configured by software, but may be configured by a logic circuit. The driver generates print data for discharging the liquid from a head unit 40 based on original image data, which serves as a base to be transferred onto a transfer target medium 200. Although the computer 90 includes the driver, the liquid discharge device 1 may include the driver.

The liquid discharge device 1 executes a print operation based on the print data received from the computer 90. The liquid discharge device 1 includes a controller 10 that controls the liquid discharge device 1, a transport unit 20 that transports the transfer medium 100, and the head unit 40 that can discharge the liquid. The liquid discharge device 1 further includes a carriage unit 30 that supports the head unit 40, a drying unit 50 that dries the transfer medium 100 onto which the liquid is discharged, and a detector group 60 that detects a situation in the liquid discharge device 1.

The controller 10 includes an interface unit (I/F) 11, a CPU 12, a memory 13, and a unit control circuit 14. The interface unit 11 transmits and receives data to and from the computer 90 and the liquid discharge device 1. The CPU 12 is an arithmetic processing device that controls the entire liquid discharge device 1. The memory 13 has an area for storing a program for the CPU 12, a work area, and the like. The unit control circuit 14 controls each unit based on the control of the CPU 12. The detector group 60 transmits a detection result obtained by monitoring the situation in the liquid discharge device 1 to the CPU 12. The controller 10 controls each unit based on the print data received from the computer 90 and the detection result received from the detector group 60.

As illustrated in FIG. 2, the transport unit 20 transports the transfer medium 100. The transport unit 20 includes two transport roller pairs 21. The two transport roller pairs 21 are disposed upstream of the head unit 40 in a -Y direction and downstream of the head unit 40 in a +Y direction, respectively. The transport unit 20 transports the transfer medium 100 from an upstream side to a downstream side in the +Y direction by rotating a motor (not illustrated) connected to the transport roller pair 21.

In FIG. 2, a roll body R1 obtained by winding the transfer medium 100 in a roll shape is disposed upstream of the two transport roller pairs 21. A roll body R2 that winds the transfer medium 100 in a roll shape is further disposed downstream of the two transport roller pairs 21. The transfer medium 100 fed from the roll body R1 passes through a position facing the head unit 40, and then is wound around the roll body R2 by rotating a motor (not illustrated) connected to the roll body R2. In FIG. 2, a transport path along which the transfer medium 100 is transported is formed in a direction along the Y axis. The transport path may be appropriately bent using another roller or the like.

The carriage unit 30 supports the head unit 40. The head unit 40 includes a head 41 that can discharge the liquid from a plurality of nozzles (not illustrated). The head 41 is disposed such that the nozzles face the transfer medium 100. The head 41 discharges the color ink C and the adhesive liquid G from the nozzles toward the transfer medium 100. The carriage unit 30 includes a carriage 31 on which the head 41 is mounted and a carriage movement mechanism 32 that reciprocates the carriage 31 in a ±X direction, which is the main scanning direction.

The drying unit 50 dries the liquid discharged onto the transfer medium 100. The drying unit 50 is disposed downstream of the head unit 40 in the +Y direction. The drying unit 50 is disposed to face the transfer medium 100. As the drying unit 50, for example, a fan is used.

The liquid discharge device 1 alternately repeats a pass operation of moving the carriage 31 in the main scanning direction and a transport operation of transporting the transfer medium 100 in the sub scanning direction. In each pass operation, the controller 10 controls the carriage unit 30 to move the carriage 31 in the main scanning direction, and controls the head unit 40 to discharge the liquid from a predetermined nozzle of the head 41 toward the transfer medium 100. In each transport operation, the controller 10 controls the transport unit 20 to transport the transfer medium 100 in the sub scanning direction by a predetermined transport amount.

By repeating the liquid discharge, the pass operation, and the transport operation, the transfer medium 100 onto which the liquid is discharged is gradually transported toward the drying unit 50. Then, the liquid discharged onto the transfer medium 100 is dried at a position facing the drying unit 50. The dried transfer medium 100 is wound around the roll body R2. The transfer medium 100 is not limited to a roll shape, and may be a single sheet shape.

### 1-2. Printing Method

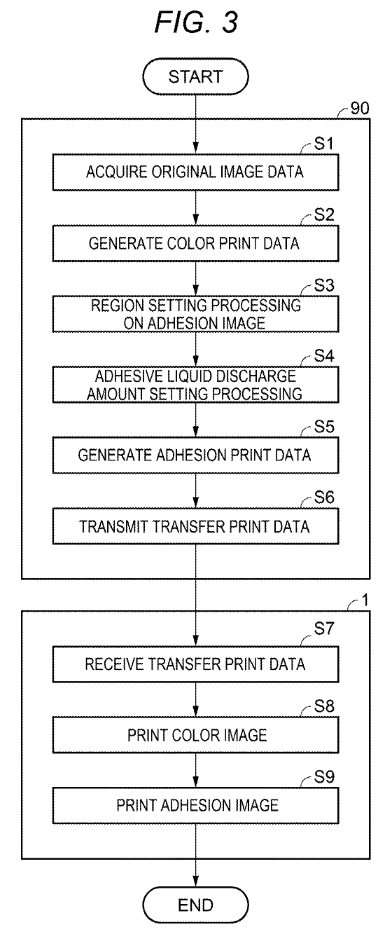

A printing method by the print system S will be described with reference to FIGS. 3 to 8. First, a flow in which the driver of the computer 90 processes the original image data will be described.

As illustrated in FIG. 3, in step S1, the driver acquires the original image data.

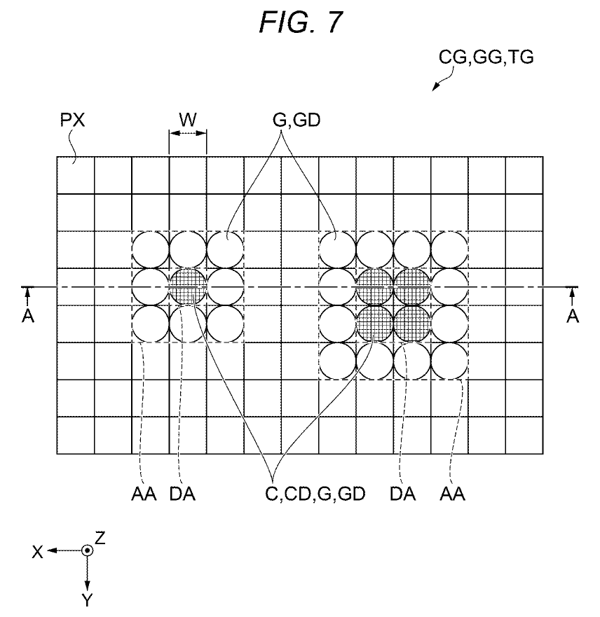

Next, in step S2, the driver generates color print data for forming a color image CG (see FIG. 4) formed by a color dot CD (see FIG. 7) formed of the color ink C. Specifically, the driver generates the color print data by performing resolution conversion processing, color conversion processing, halftone processing, rasterization processing, and the like.

The resolution conversion processing converts a resolution of the original image data into a resolution of the color print data. The color conversion processing converts a color space of the original image data into a color space of an ink color. The halftone processing converts color-converted high gradation data into low gradation data that can be expressed by the liquid discharge device 1.

In the halftone processing, for example, data for one pixel expressed by 256 gradations is converted into 2-bit data with four gradations that can form dots of each size including "no dot", "small dot", "medium dot", and "large dot". As the size of the dot increases, the dot is converted into a dot having a larger liquid discharge amount. In the following description, 2-bit data corresponding to "no dot", "small dot", "medium dot", and "large dot" is referred to as dot data.

In the rasterization processing, based on the dot data generated by the halftone processing, the color ink C is discharged from a predetermined nozzle of the head 41, and the dot data is rearranged in an order in which dots can be formed on the transfer medium 100.

Next, in step S3, the driver performs region setting processing on an adhesion image GG (see FIG. 5) for discharging the adhesive liquid G to overlap the color image CG. The adhesion image GG is an image formed by adhesive dots GD (see FIG. 7) formed of the adhesive liquid G. The region setting processing on the adhesion image GG is processing of setting, based on the generated color print data, an adjacent region AA (see FIG. 7) adjacent to the color image CG in addition to a region in which the color image CG is formed. The adjacent region AA may be set by the driver, or may be designated by a designation unit that is a user interface displayed by the driver. Details of the color image CG, the adhesion image GG, and the adjacent region AA will be described later.

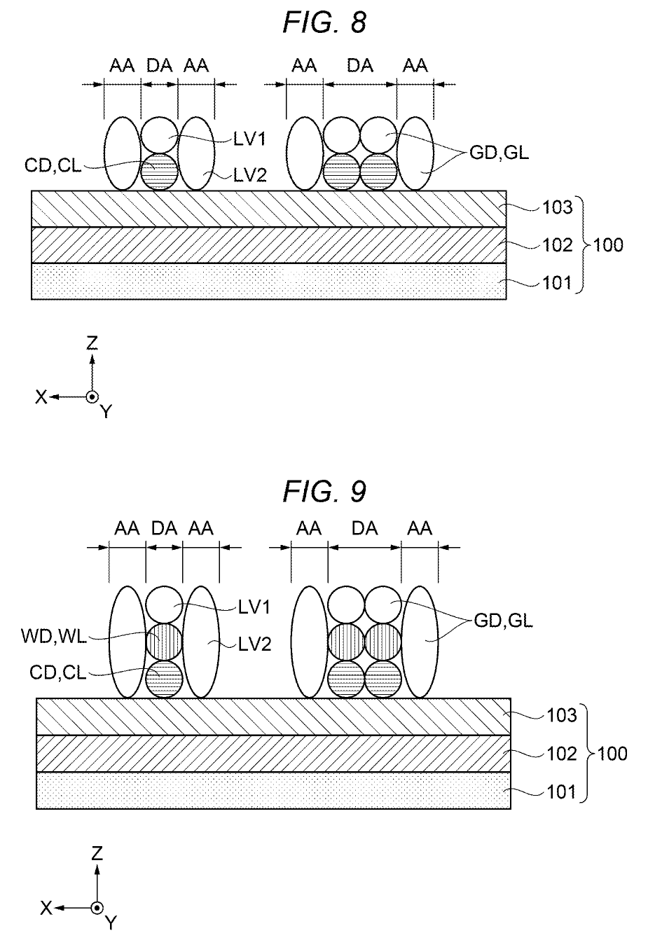

Next, in step S4, the driver performs adhesive liquid discharge amount setting processing. In the adhesive liquid discharge amount setting processing, the driver generates adhesive liquid discharge amount data to discharge the adhesive liquid G of a first amount LV1 (see FIG. 8) per unit area to overlap the color image CG. In the adhesive liquid discharge amount setting processing, the driver generates adhesive liquid discharge amount data to discharge the adhesive liquid G of a second amount LV2 (see FIG. 8), which is larger than the first amount LV1, per unit area to the adjacent region AA which is a region to which the color ink C is not discharged and which is adjacent to the color image CG.

Next, in step S5, the driver generates adhesion print data for forming the adhesion image GG formed by the adhesive dots GD formed of the adhesive liquid G based on results of the region setting processing on the adhesion image GG in step S3 and the adhesive liquid discharge amount setting processing in step S4.

Next, in step S6, the driver transmits transfer print data including the color print data generated in step S2 and the adhesion print data generated in step S5 to the liquid discharge device 1.

Next, in step S7, the liquid discharge device 1 receives the transfer print data transmitted from the computer 90. Next, in step S8, the controller 10 provided in the liquid discharge device 1 prints the color image CG on the transfer medium 100 by performing the discharge of the color ink C and the pass operation based on the received transfer print data. Next, in step S9, the controller 10 prints the adhesion image GG to overlap the color image CG printed in step S8 by performing the discharge of the adhesive liquid G and the pass operation based on the received transfer print data. The adhesion image GG printed on the transfer medium 100 is printed to cover the color image CG. The liquid discharge device 1 repeats the discharge of the liquid, the pass operation, and the transport operation.

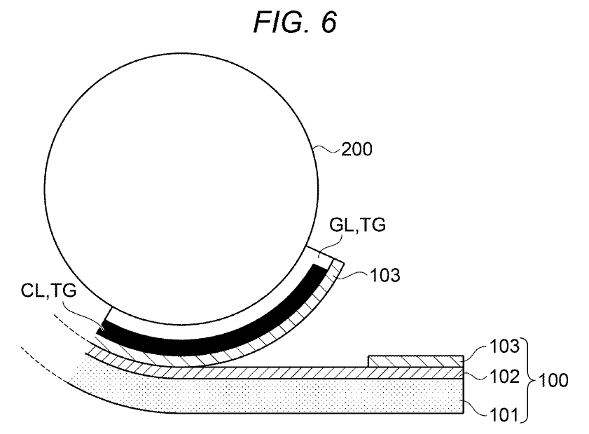

With the printing method as described above, the print system S can print a transfer image TG (see FIG. 6) including the color image CG and the adhesion image GG on the transfer medium 100.

### 1-3. Formation Order of Transfer Image

With reference to FIGS. 4 to 6, a formation order of a color image layer CL (see FIG. 4) on which the color image CG is formed and an adhesion image layer GL (see FIG. 5) on which the adhesion image GG is formed, and how the transfer image TG (see FIG. 6) printed on the transfer medium 100 is transferred to the transfer target medium 200 (see FIG. 6) will be described.

As illustrated in FIG. 4, the transfer medium 100 includes a base material 101, a release layer 102 formed on the base material 101, and a transfer layer 103 formed on the release layer 102. The transfer medium 100 has a sheet shape or a film shape.

The base material 101 is, for example, a PET film having a thickness of 25 μm, and is not limited thereto. Other plastics, metals, wood, paper, or the like may be used. The release layer 102 is a layer for improving transferability for which the transfer image TG (see FIG. 6) is peeled off from the transfer medium 100 and transferred to the transfer target medium 200 (see FIG. 6). The release layer 102 is formed as, for example, a layer of a dried polyethylene wax-based release agent, is not limited thereto, and may be formed using a silicone-based release agent, a fluorine-based release agent, or the like. The transfer layer 103 is a layer that receives the color image layer CL transferred to the transfer target medium 200 and is to be transferred to the transfer target medium 200.

In the transfer medium 100, for example, a peeling layer between the release layer 102 and the transfer layer 103 may be formed to further improve the transferability of the transfer layer 103. In the transfer medium 100, for example, a static conductive layer on a surface on a side opposite to the release layer 102 among surfaces of the base material 101 may be formed to prevent static electricity.

In FIG. 4, for convenience of description, one nozzle 42C that discharges the color ink C and one nozzle 42G that discharges the adhesive liquid G (see FIG. 5) are illustrated, but the head 41 includes a plurality of the nozzles 42C that discharge the color ink C and a plurality of the nozzles 42G that discharge the adhesive liquid G. In the plurality of nozzles 42C that discharge the color ink C, the plurality of nozzles 42C are arranged in series to form nozzle rows and are arranged at predetermined pitch intervals in a nozzle row direction. The predetermined pitch is appropriately set according to dot per inch (dpi) of a print resolution. The nozzle rows are arranged for each color of the color ink C at predetermined intervals in a direction intersecting the nozzle rows. Similarly, in the plurality of nozzles 42G that discharge the adhesive liquid G, the plurality of nozzles 42G are arranged in series to form nozzle rows. The plurality of nozzles 42G that discharge the adhesive liquid G are arranged to be able to discharge the adhesive liquid G to overlap the color ink C discharged previously.

The liquid discharge device 1 can print the color image CG having a resolution of, for example, 600 dpi or 1200 dpi in the main scanning direction by repeating the pass operation of the head 41 and the transport operation of the transfer medium 100. The liquid discharge device 1 can print the color image CG having a resolution of 600 dpi or 1200 dpi in the sub scanning direction.

First, the controller 10 forms the color image layer CL on a surface of the transfer layer 103 by performing the pass operation in the +X direction while discharging the color ink C from the nozzle 42C. In the embodiment, the color ink C includes a cyan ink, a magenta ink, a yellow ink, a black ink, a white ink, and the like. The color image CG may be formed of, for example, color inks C in a plurality of colors including a black ink, a white ink, and the like, or may be formed of the color ink C in a single color.

Next, as illustrated in FIG. 5, after forming the color image layer CL on the surface of the transfer layer 103, the controller 10 performs the pass operation in the +X direction while discharging the adhesive liquid G from the nozzle 42G. Accordingly, the controller 10 forms the adhesion image layer GL on the surface of the transfer layer 103 and a surface of the color image layer CL. The adhesion image layer GL is a layer for covering the color image layer CL and adhering a part of the transfer layer 103 to the transfer target medium 200. In the embodiment, for example, an aqueous liquid containing a thermoplastic resin in an emulsion form is used as the adhesive liquid G, and a viscosity of the adhesive liquid G is set to be higher than a viscosity of the color ink C.

The adhesion image layer GL is dried by the drying unit 50. Accordingly, the transfer medium 100 on which the adhesion image layer GL is formed can be wound to come into contact with a back surface of the base material 101. The adhesion image layer GL can exhibit adhesiveness by heating the thermoplastic resin when being transferred to the transfer target medium 200. In the embodiment, an underlayer WL (see FIG. 9) for improving color development of the color image layer CL may be formed between the color image layer CL and the adhesion image layer GL. The white ink can also be used for the underlayer WL.

Next, how the transfer image TG is transferred from the transfer medium 100 to the transfer target medium 200 will be described with reference to FIG. 6. The transfer image TG includes the color image layer CL, the adhesion image layer GL, and a part of the transfer layer 103 overlapping these layers. The transfer layer 103 may not be necessarily provided as long as the color image layer CL is transferred. When the transfer medium 100 is heated to transfer the transfer image TG to the transfer target medium 200, an adhesive force is generated in the adhesion image layer GL located on the surface of the transfer medium 100.

As illustrated in FIG. 6, when the transfer medium 100 in contact with a transfer surface of the transfer target medium 200 is heated, the transfer layer 103 is peeled off from the release layer 102, and the transfer image TG is transferred to the transfer target medium 200. The adhesion image layer GL, the color image layer CL, and the transfer layer 103 are transferred in this order on the transfer target medium 200 after the transfer from a transfer target medium 200 side. The transfer of the transfer image TG to the transfer target medium 200 can also be performed using a heat press machine or the like.

Since the transfer medium 100 has a sheet shape or a film shape, even when the transfer surface of the transfer target medium 200 is a flat surface or a curved surface, it is easy to transfer the transfer image TG on the surface. Therefore, the transfer medium 100 can be transferred to various transfer target media 200, such as a cloth product such as a T-shirt, a daily product such as a mug, and an industrial product such as a plate material.

In FIGS. 4 to 6, each layer of the color image layer CL and the adhesion image layer GL is clearly separated, but in practice, each layer is not limited to being clearly separated. For example, when the adhesive liquid G for forming the adhesion image layer GL is discharged before the color ink C for forming the color image layer CL is dried to a necessary and sufficient degree, the color ink C and the adhesive liquid G may be partially mixed.

When each layer is formed by an inkjet method, a layer structure does not necessarily have the order illustrated in FIGS. 4 to 6. For example, in a case of an image in which the density of the color image CG is low, the color image layer CL in which a plurality of the color dots CD formed of the color ink C are dispersed with gaps may be formed. Therefore, the adhesive dots GD may be provided in the gaps of the color image layer CL depending on the density of the color image CG.

### 1-4. Dot Formation on Transfer Medium

FIGS. 7 to 9 are views of dots formed on the transfer medium 100. In FIGS. 7 to 9, the adhesive dot GD is indicated by a white circle for each pixel PX. In FIG. 7, the color dot CD with which the adhesive dot GD overlaps is indicated by a circle with grid hatching for each pixel PX. In FIGS. 8 and 9, the color dot CD is indicated by a horizontal hatched circle for each pixel PX. In FIG. 9, a white dot WD is indicated by a vertical hatched circle for each pixel PX.

In each drawing, for convenience of description, the adhesive dot GD, the color dot CD, and the white dot WD are schematically illustrated as circular shapes, but in practice, each dot does not necessarily indicate a circular shape. Since each dot is a liquid, the shape is easily deformed. For example, the adhesive dots GD having the same composition as each other are likely to form an integrated layer shape when the adhesive dots GD adhere to each other.

A width W of one pixel PX illustrated in FIG. 7 may be appropriately set to, for example, 1/600 inches according to the resolution of the color image CG to be printed or the resolution of the adhesion image GG. In the embodiment, the resolution of the color image CG and the resolution of the adhesion image GG are both formed at a resolution of 600 × 600 (dpi).

As illustrated in FIG. 7, a region in which the color dot CD with which the adhesive dot GD overlaps is formed, that is, a region in which a circle with grid hatching is disposed is illustrated as an overlapping region DA. A region to which the color dot CD is not discharged and which is adjacent to the color dot CD, that is, a region in which the white circle is disposed is illustrated as an adjacent region AA.

In the embodiment, the controller 10 discharges the first amount LV1 of the adhesive liquid G per unit area in the overlapping region DA in which the adhesion image GG formed by the adhesive dot GD formed of the adhesive liquid G is superimposed on the color image CG formed by the color dot CD formed of the color ink C. The controller 10 discharges the second amount LV2 of the adhesive liquid G, which is larger than the first amount LV1, per unit area to the adjacent region AA which is a region to which the color ink C is not discharged and which is adjacent to the color image CG. The phrase "adhesion image GG formed by the adhesive dot GD formed of the adhesive liquid G is superimposed on the color image CG formed by the color dot CD formed of the color ink C" means that it is necessary to place the adhesive liquid G on the color image CG to realize the transfer of the color image CG to the transfer target medium 200. For example, even when the adhesive liquid G is not placed on the color image CG immediately after the adhesive liquid G is discharged, when the adhesive liquid G spreads in a region essential for implementing the transfer at least after the landing of the adhesive liquid G and before the transfer, the region in which the adhesive liquid G spreads can be interpreted as an "overlapping region".

In other words, the controller 10 discharges the first amount LV1 of the adhesive liquid G per unit area to overlap the color image CG, and discharges the second amount LV2 of the adhesive liquid G, which is larger than the first amount LV1, per unit area to the adjacent region AA. That is, in the region in which the adhesion image GG is formed, the adhesive dot GD is formed at a predetermined discharge Duty even in the adjacent region AA in which a discharge Duty of the color ink C is zero. Therefore, the color image CG is included in the region in which the adhesion image GG is formed. Accordingly, the transfer image TG is transferred to the transfer target medium 200 with high transferability.

As illustrated in FIG. 7, in the embodiment, the adjacent region AA is set by the driver to surround the overlapping region DA with the width W of one pixel PX. In the adjacent region AA, the discharge Duty of the color ink C is zero, and the adhesive dot GD is formed in the adjacent region AA. Therefore, the transfer layer 103 corresponding to a width of the adjacent region AA is transferred to the transfer target medium 200. In contrast, since the adhesive dot GD is not formed in a region outside the adjacent region AA, the transfer layer 103 corresponding to the region outside the adjacent region AA is not transferred.

FIG. 8 illustrates a state in which the color image layer CL and the adhesion image layer GL are formed as two layers in this order on the transfer medium 100. As illustrated in FIG. 8, in the adjacent region AA, the adhesive dot GD is discharged with the second amount LV2, which is an amount larger than the first amount LV1 discharged to the overlapping region DA. In this case, the adhesive dot GD discharged to the adjacent region AA lands on the transfer layer 103 of the transfer medium 100 while adhering to the adjacent color dot CD. That is, the adhesive dot GD is formed long in a thickness direction of the adjacent color image CG by increasing the amount of the adhesive liquid G discharged to the adjacent region AA.

Specifically, the controller 10 makes the second amount LV2 larger than the first amount LV1 by making the size of the adhesive dot GD discharged to the adjacent region AA larger than the size of the adhesive dot GD discharged to the overlapping region DA. In the embodiment, the first amount LV1 is an amount corresponding to the "small dot" and the "medium dot", and the second amount LV2 is an amount larger than any one amount selected from the two first amounts LV1. For example, when the first amount LV1 corresponds to the "small dot", the second amount LV2 is an amount corresponding to the "medium dot" or the "large dot". Specifically, for example, when the adhesive dot GD having a size of the "medium dot" is discharged to the overlapping region DA, the adhesive dot GD having a size of the "large dot" is discharged to the adjacent region AA.

In this way, in the embodiment, even when a discharge amount of the color ink C is large, the color image CG can be three-dimensionally covered with the adhesive liquid G and the transfer layer 103. Accordingly, it is possible to prevent the color ink C from naturally spreading on the surface of the transfer medium 100.

FIG. 9 illustrates a state in which the color image layer CL, the underlayer WL, and the adhesion image layer GL are formed in this order as three layers on the transfer medium 100. The underlayer WL is a layer for improving the color development of the color image CG, and is formed by superimposing the white dot WD formed of the white ink on the color dot CD. In this case, the discharge amount of the ink of the white dot WD as the underlayer WL is added to the discharge amount of the ink of the color dot CD. Therefore, a total amount of the discharged color ink C increases, but even in this case, the color image CG can be three-dimensionally covered with the adhesive liquid G and the transfer layer 103. Accordingly, it is possible to prevent the color ink C from naturally spreading on the surface of the transfer medium 100.

As described above, according to the printing method and the liquid discharge device 1 of the first embodiment, the following effects can be obtained.

According to this printing method, the first amount LV1 of the adhesive liquid G per unit area is discharged to the overlapping region DA in which the adhesion image GG formed by the adhesive dot GD formed of the adhesive liquid G is superimposed on the color image CG formed by the color dot CD formed of the color ink C. The second amount LV2 of the adhesive liquid G, which is larger than the first amount LV1, per unit area is discharged to the adjacent region AA which is a region in which the color ink C is not discharged and which is adjacent to the color image CG. That is, by discharging the second amount LV2 of the adhesive liquid G to the adjacent region AA adjacent to the color image CG, the adhesive dot GD can be formed long in the thickness direction of the adjacent color image CG. Accordingly, since it is possible to prevent the color image CG from naturally spreading on the surface of the transfer medium 100, it is possible to prevent the contour of the color image CG from being disturbed even when the amount of the color ink C increases.

According to the printing method, since the viscosity of the adhesive liquid G is higher than the viscosity of the color ink C, it is possible to prevent the color dot CD from naturally spreading on the surface of the transfer medium 100.

According to this printing method, the size of the adhesive dot GD discharged to the adjacent region AA is made larger than the size of the adhesive dot GD discharged to the overlapping region DA. Accordingly, the discharge amount of the adhesive liquid G discharged to the adjacent region AA can be increased.

According to the printing method, since the adjacent region AA surrounds the overlapping region DA with the width W corresponding to one pixel PX, it is possible to reduce a discharge area of the adhesive liquid G in the adjacent region AA. When the transfer image TG formed in this way is transferred to the transfer target medium 200, the transfer layer 103 of the transfer medium 100 in the region to which the adhesive liquid G is discharged is transferred to the transfer target medium 200. Therefore, reflection of light by the transfer layer 103 may also be seen in the adjacent region AA in which the color image CG is not formed. However, according to the embodiment, since the width of the adjacent region AA is the width W for one pixel PX, unnecessary light reflection of the transfer layer 103 in the adjacent region AA can be reduced as compared with the case in which the width of the adjacent region AA is for a plurality of pixels PX.

According to the liquid discharge device 1, the liquid discharge device 1 discharges the first amount LV1 of the adhesive liquid G per unit area to the overlapping region DA in which the adhesion image GG formed by the adhesive dot GD formed of the adhesive liquid G is superimposed on the color image CG formed by the color dot CD formed of the color ink C. The second amount LV2 of the adhesive liquid G, which is larger than the first amount LV1, per unit area is discharged to the adjacent region AA which is a region in which the color ink C is not discharged and which is adjacent to the color image CG. That is, by discharging the second amount LV2 of the adhesive liquid G to the adjacent region AA adjacent to the color image CG, the adhesive dot GD can be formed long in the thickness direction of the adjacent color image CG. Accordingly, since it is possible to prevent the color image CG from naturally spreading on the surface of the transfer medium 100, it is possible to prevent the contour of the color image CG from being disturbed even when the amount of the color ink C increases.

### 2. Second Embodiment

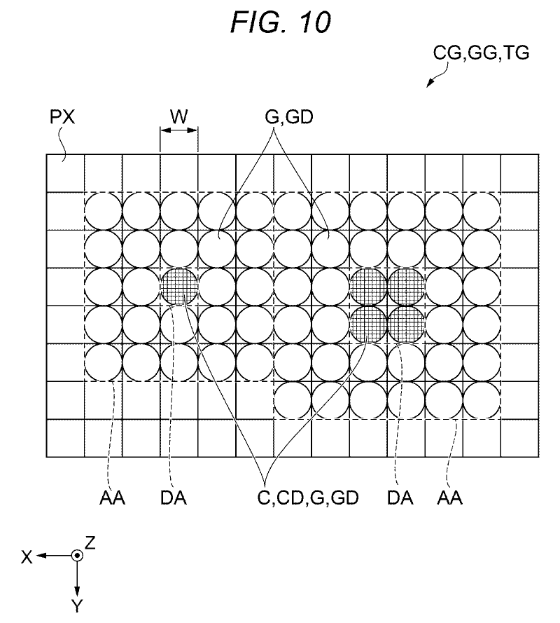

Hereinafter, dots formed on the transfer medium 100 in a second embodiment will be described with reference to FIG. 10. In the second embodiment, the same configurations as those in the previously mentioned drawings are denoted by the same reference numerals, and the detailed description thereof will be omitted.

In the second embodiment, a width of the adjacent region AA can be changed. A method of changing the width of the adjacent region AA is to change the width, for example, by a user designating any information in a designation unit displayed by a driver. In the designation of the width of the adjacent region AA, for example, an "image quality priority mode" in which the width of the adjacent region AA is set to one pixel PX in advance may be selected from the display of the designation unit. Alternatively, in the designation of the width of the adjacent region AA, a "durability priority mode" in which the width of the adjacent region AA is set to five pixels PX in advance may be selected from the display of the designation unit. Alternatively, in the designation of the width of the adjacent region AA, the number of pixels PX may be directly input to the designation unit. The width of the adjacent region AA may be designated by the liquid discharge device 1.

FIG. 10 illustrates a case in which the width of the adjacent region AA surrounding the overlapping region DA is twice the width W of one pixel PX. However, the width of the adjacent region AA is not limited thereto. For example, the adjacent region AA may surround the overlapping region DA by three to five times the width W of one pixel PX, or may surround the overlapping region DA by six or more times the width W of one pixel PX. That is, the adjacent region AA can surround the overlapping region DA with a width larger than the width W of one pixel PX.

As described above, according to the second embodiment, it is possible to further obtain the following effects in addition to substantially the same effects as those of the first embodiment.

According to a printing method of the second embodiment, since the width of the adjacent region AA can be changed, the width of the adjacent region AA can be designated to any size. For example, by changing the width of the adjacent region AA, the user can adjust a degree of unnecessary light reflection in a region other than the color image CG transferred to the transfer target medium 200 and a degree of fastness to washing of the transfer image TG transferred to the transfer target medium 200.

According to the printing method, the adjacent region AA surrounds the overlapping region DA with a width larger than the width W of one pixel PX. Accordingly, since an area of the adjacent region AA to which the adhesive liquid G is discharged can be increased, it is possible to improve transferability to the transfer target medium 200 and to improve fastness to washing of the transferred transfer image TG.

### 3. Third Embodiment

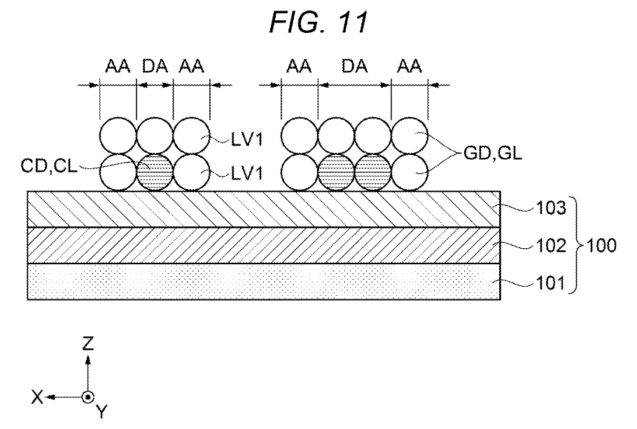

Hereinafter, dots formed on the transfer medium 100 in a third embodiment will be described with reference to FIG. 11. In the third embodiment, the same configurations as those in the previously mentioned drawings are denoted by the same reference numerals, and the detailed description thereof will be omitted.

As illustrated in FIG. 11, first, in a first pass operation, the color dot CD is discharged to a surface of the transfer layer 103. In a subsequent second pass operation, the adhesive dot GD is discharged to the adjacent region AA adjacent to the color dot CD. In the subsequent third pass operation, the adhesive dot GD is further discharged to overlap the color dot CD discharged in the first pass operation and the adhesive dot GD discharged in the second pass operation. The adhesive dot GD discharged in the second pass operation is discharged with the first amount LV1. The adhesive dot GD discharged in the third pass operation is also discharged with the first amount LV1.

That is, the amount of the adhesive dot GD discharged in the second pass operation and the amount of the adhesive dot GD discharged in the third pass operation are both discharged as the first amount LV1. Specifically, for example, in the second pass operation, the adhesive dot GD having a size of the "large dot" is discharged to the adjacent region AA, and in the third pass operation, the adhesive dot GD having the size of the "large dot" is discharged to the overlapping region DA and the adjacent region AA. Accordingly, it is possible to discharge the first amount LV1 of the adhesive liquid G per unit area to the overlapping region DA and discharge the second amount LV2 of the adhesive liquid G, which is larger than the first amount LV1, per unit area to the adjacent region AA.

In other words, the second amount LV2 is made larger than the first amount LV1 by making the number of adhesive dots GD discharged to the adjacent region AA larger than the number of adhesive dots GD discharged to the overlapping region DA per unit area.

As described above, according to the third embodiment, it is possible to further obtain the following effects in addition to substantially the same effects as those of the first embodiment.

According to a printing method of the third embodiment, the second amount LV2 is made larger than the first amount LV1 by making the number of adhesive dots GD discharged to the adjacent region AA larger than the number of adhesive dots GD discharged to the overlapping region DA per unit area. Accordingly, the discharge amount of the adhesive liquid G discharged to the adjacent region AA can also be increased. It is possible to form the adhesive dot GD at a maximum discharge Duty in both the overlapping region DA and the adjacent region AA.

### 4. Fourth embodiment

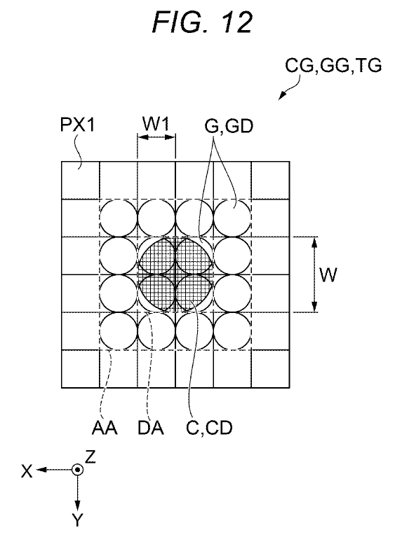

Hereinafter, dots formed on the transfer medium 100 in a fourth embodiment will be described with reference to FIG. 12. In the above-described embodiments, the resolution of the color image CG and the resolution of the adhesion image GG are the same, but the present disclosure is not limited thereto. The color image CG illustrated in FIG. 12 has a resolution of, for example, 600 × 600 dpi, and the adhesion image GG has a resolution of 1200 × 1200 dpi. In the fourth embodiment, the same configurations as those in the previously mentioned drawings are denoted by the same reference numerals, and the detailed description thereof will be omitted.

As illustrated in FIG. 12, a width W1 of one pixel PX1 of the adhesive dot GD is 1/1200 inch, and the width W of one pixel of the color dot CD is 1/600 inch. In this way, even when the resolutions of the color image CG and the adhesion image GG are different, the color dot CD and the adhesive dot GD can be formed to overlap each other.

In the fourth embodiment, the resolution of the adhesion image GG is higher than the resolution of the color image CG. Since the resolution of the adhesion image GG is twice the resolution of the color image CG, the adhesive dot GD is discharged as pixels corresponding to 1/4 pixels of the color dot CD. Accordingly, since the width W1 of one pixel PX1 of the adhesive dot GD in the adjacent region AA is less than that in the other embodiments described above, it is possible to further reduce unnecessary light reflection in a region other than the color image CG transferred to the transfer target medium 200. It is also possible to maintain transferability for transferring the transfer image TG to the transfer target medium 200.

Each embodiment has been described above in detail with reference to the drawings, but the specific configuration is not limited to each embodiment, and may be changed, substituted, or deleted as long as it does not deviate from the gist of this disclosure. The following other embodiments may also be used. The other embodiments can obtain the same effects as those of the above embodiments.

In each of the above embodiments, a region adjacent to the entire periphery of the color image CG is illustrated as the adjacent region AA, but the adjacent region AA is not limited thereto. The adjacent region AA may be a region adjacent to a part of the periphery of the color image CG. That is, the adjacent region AA may be a region adjacent to at least one dot of the color dots CD. For example, in FIG. 7, a case in which the adhesive liquid G is discharged except for only one pixel PX in the adjacent region AA will be described. In this case, by discharging a sufficient amount of the second amount LV2 to a region adjacent to one pixel PX to which the adhesive liquid G is not discharged, the adhesive liquid G can be spread toward one pixel PX to which the adhesive liquid G is not discharged. As a result, it is possible to prevent the color image CG from naturally spreading.

In each of the above embodiments, the formation of the color image layer CL and the formation of the adhesion image layer GL are performed by different pass operations in the +X direction, but the formation is not limited thereto. For example, the color image layer CL may be formed by a pass operation in the +X direction, and then the adhesion image layer GL may be formed by a pass operation in the -X direction. Accordingly, the liquid discharge device 1 can improve the throughput of printing.

In each of the above embodiments, the nozzle rows that discharge the adhesive liquid G may be arranged to sandwich the nozzle rows that discharge the color ink C in the main scanning direction. Accordingly, since the liquid discharge device 1 can form the transfer image TG in each of the reciprocating pass operations, it is possible to improve the throughput of printing.

In each of the above embodiments, the head 41 includes the plurality of nozzles 42C that discharge the color ink C and the plurality of nozzles 42G that discharge the adhesive liquid G, but the present disclosure is not limited thereto. The plurality of nozzles 42C that discharge the color ink C may be provided in a color head that can discharge only the color ink C, and the plurality of nozzles 42G that discharge the adhesive liquid G may be provided in an adhesive head that can discharge only the adhesive liquid G. That is, the color head and the adhesive head may be provided separately. For example, the adhesive head may be provided downstream of the color head in the transport direction. Accordingly, the liquid discharge device 1 can improve the throughput of printing.

What is claimed is:

1. A printing method for performing printing on a transfer medium using a liquid discharge device including a nozzle configured to discharge a color ink and a nozzle configured to discharge an adhesive liquid, the printing method comprising:
discharging a first amount of the adhesive liquid per unit area to an overlapping region in which an adhesion image formed by an adhesive dot formed of the adhesive liquid is superimposed on a color image formed by a color dot formed of the color ink; and
discharging a second amount of the adhesive liquid per unit area to an adjacent region that is a region to which the color ink is not discharged and that is adjacent to the color image, the second amount being larger than the first amount.

2. The printing method according to claim 1, wherein
a viscosity of the adhesive liquid is higher than a viscosity of the color ink.

3. The printing method according to claim 1, wherein
the second amount is made larger than the first amount by making a size of the adhesive dot discharged to the adjacent region larger than a size of the adhesive dot discharged to the overlapping region.

4. The printing method according to claim 1, wherein
the second amount is made larger than the first amount by making the number of the adhesive dots discharged to the adjacent region larger than the number of the adhesive dots discharged to the overlapping region per unit area.

5. The printing method according to claim 1, wherein
the adjacent region surrounds the overlapping region with a width of one pixel.

6. The printing method according to claim 1, wherein
the adjacent region surrounds the overlapping region with a width larger than a width of one pixel.

7. The printing method according to claim 1, wherein
a width of the adjacent region is changeable.

8. A liquid discharge device comprising:
a nozzle configured to discharge a color ink; and
a nozzle configured to discharge an adhesive liquid, wherein
a first amount of the adhesive liquid per unit area is discharged to an overlapping region in which an adhesion image formed by an adhesive dot formed of the adhesive liquid is superimposed on a color image formed by a color dot formed of the color ink, and
a second amount of the adhesive liquid per unit area is discharged to an adjacent region that is a region to which the color ink is not discharged and that is adjacent to the color image, the second amount being larger than the first amount.
